(19) United States
(12) Patent Application Publication
(10) Pub. No.: US 2008/0104092 A1
(43) Pub. Date: May 1, 2008

(54) Integrating Business Rules into Automated Business Processes

(75) Inventor: Fred A. Cummins, Farmington Hills, MI (US)

Correspondence Address: BAKER BOTTS L.L.P., 2001 ROSS AVENUE, 6TH FLOOR, DALLAS, TX, 75201-2980, US

(73) Assignee: Electronic Data Systems Corporation, Plano, TX (US)

(21) Appl. No.: 11/553,823

(22) Filed: Oct. 27, 2006

(51) Int. Cl. G06F 7/00

(52) U.S. Cl. 707/101

(57) ABSTRACT

A method for integrating business rules into automated business processes comprising identifying an entity affected by a data update initiated by a step of an automated business process. The method further comprises accessing a rule registry comprising a plurality of business rules, each business rule corresponding to one or more entities, and determining which business rules in the rule registry to evaluate by determining from the plurality of business rules one or more business rules that correspond to the entity affected by the data update. The method further comprises, for each of the business rules determined to correspond to the entity affected by the data update, evaluating the business rule in context to determine whether performing the data update would violate the business rule and, if it is determined that performing the data update would violate the business rule, raising an exception in accordance with the violated business rule.

### TECHNICAL FIELD OF THE INVENTION

This invention relates generally to business management and more particularly to integrating business rules into automated business processes.

### BACKGROUND

Business enterprises or other suitable organizations often employ a number of business rules in their operations. In general, business rules define how business is conducted, such as by defining constraints on how business should be conducted. As examples, some business rules may help ensure that the enterprise is employing best business practices, some business rules may help ensure accountability and control, some business rules may help ensure quality or timeliness, and some business rules may help minimize or prevent risk or loss. As another example, some business rules may help ensure that an enterprise is complying with one or more government regulations.

A business rule may apply at a variety of points in the operation of an enterprise. Additionally, business rules may be incorporated into an enterprise in a variety of ways. For example, business rules may be implemented through human actions directed by instructions or orders (e.g., employee compliance with a manager's instructions). As another example, business rules may be implemented by decisions incorporated into business processes that are implemented in computer applications, with the business rules being hard-coded into the computer applications. These computer applications may include applications that are coded in conventional ways, applications that are generated from models, and applications referred to as Business Process Management Systems that execute business process specifications.

### SUMMARY

According to the present invention, disadvantages and problems associated with previous techniques for integrating business rules into business processes may be reduced or eliminated.

A method for integrating business rules into automated business processes comprising identifying an entity affected by a data update initiated by a step of an automated business process. The method further comprises accessing a rule registry comprising a plurality of business rules, each business rule corresponding to one or more entities, and determining which business rules in the rule registry to evaluate by determining from the plurality of business rules one or more business rules that correspond to the entity affected by the data update. The method further comprises, for each of the business rules determined to correspond to the entity affected by the data update, evaluating the business rule in context to determine whether performing the data update would violate the business rule and, if it is determined that performing the data update would violate the business rule, raising an exception in accordance with the violated business rule.

Particular embodiments of the present invention may provide one or more technical advantages. In certain embodiments, the present invention may enable consistent application of business rules throughout an enterprise. In certain embodiments, the present invention organizes or indexes business rules that describe the bounds of acceptable operation of the enterprise, so that the business rules can be evaluated with respect to updates to data relating to particular entities and attributes. In certain embodiments, the present invention allows general rules that are potentially applicable across multiple business processes or contexts to be evaluated at appropriate points in a controlled, reliable way. In certain embodiments, the present invention enables business rules to be evaluated “in context.” In certain embodiments, the present invention provides a mechanism for monitoring violations of business rules such as the generation of an event notification when a violation is detected. Moreover, the detection of a violation of a business rule may result in the initiation of one or more processes.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 illustrates an example system for integrating business rules into automated business processes according to certain embodiments of the present invention;

FIG. 2 illustrates an example method for deploying a business rule according to certain embodiments of the present invention;

FIG. 3 illustrates an example method for removing a business rule according to certain embodiments of the present invention; and

FIG. 4 illustrates an example method for executing one or more business rules according to certain embodiments of the present invention.

### DESCRIPTION OF EXAMPLE EMBODIMENTS

FIG. 1 illustrates an example system 10 for integrating business rules into automated business processes according to certain embodiments of the present invention. In certain embodiments, system 10 includes one or more user systems 12, one or more databases 14, and one or more networks 16. Although an example implementation of system 10 is illustrated and primarily described, the present invention contemplates any suitable implementation of system 10.

System 10 or portions of system 10 may be associated with a business enterprise or other suitable organization. Although throughout the remainder of this description it is assumed that system 10 (or portions of system 10) is associated with an enterprise such as a business, it should be understood that system 10 (or portions of system 10) may be associated with any suitable organization (whether business-related or not). Enterprises such as the one associated with system 10 may operate (or may wish to operate) according to one or more business rules. As examples, some business rules may help ensure that the enterprise is employing best business practices, some business rules may ensure accountability and control, some business rules may help ensure quality or timeliness, and some business rules may help minimize or prevent risk or loss. As another example, some business rules may help ensure that an enterprise is complying with one or more government regulations. Business rules may be an expression of business requirements and may reflect management intent. Additionally, some enterprises such as a large, global enterprise may have thousands or tens of thousands of business rules.

In general, business rules define how business is conducted, such as by defining constraints on how business should be conducted. As an example, a business rule may include one or more conditional expressions that define the bounds of acceptable operation of the business. Business rules are typically (but not necessarily) policy-level rules. Business rules may be used to affect the operations of a business (e.g., by limiting the conditions under which a certain operation may be performed), to analyze certain behavior within a business, a combination of these, or for any other suitable purpose. As an example, one form of enterprise analysis, planning, and improvement may include focusing on analysis of the business rules of the enterprise. Business rules may also involve the behavior of people associated with the business, such as employees or clients for example. Business rules are distinguishable from rules of data integrity. For example, a rule of data integrity may specify that a particular value being stored in a database must be an integer. Rather, business rules relate to the intended bounds of enterprise operations.

Conventionally, business rules have been implemented in a business in a variety of ways, often being embedded in computer applications that implement business processes (e.g., such as decisions hard-coded into computer applications). In some cases, business rules have been implemented through human actions directed by instructions or orders (e.g., employee compliance with a manager's instructions). In other cases, computer applications that implement business processes may explicitly invoke a rules engine at particular points in particular business processes where particular business rules are applicable, which may carry significant overhead and confine the application of business rules to subject matter and points in a business process where extensive rule logic is relevant (e.g., order validation or claims processing). As yet another example, business rules have been implemented through manual reviews of proposals and/or through inspections.

Embedding business rules in computer applications that implement business processes may affect edits and process flow. Moreover, embedding particular business rules into computer applications that implement business processes typically involves explicit modification of those computer applications and business processes to include and apply the particular business rules. Furthermore, to analyze or otherwise apply the business rules of an enterprise, consultants or employees of the enterprise have been required to manually review the collection of business rules, if such a distinct collection even exists. As described above, this may be a particularly burdensome task if an enterprise has a large number of business rules embedded throughout a number of business processes implemented in computer applications (e.g., as may be the case for a large, global enterprise). As software developers for the enterprise are developing systems or designing business processes, those developers may define what specific decisions would have to be made to comply with the business rules. This may be a difficult, time consuming, and error-prone process for determining how and where to implement the business rules.

Moreover, with certain conventional techniques for integrating business rules into business processes, it may be difficult to implement a global change to a business rule because, to ensure pervasive integration of the change into relevant business processes or steps of business processes, all instances of implementation of that particular business rule would have to be found in the computer applications that include or that need to include the changed business rule with no real mechanism for doing so. For example, it may be appropriate or helpful for managers or other individuals to be able to deploy, modify, or delete rules and be assured that the impact of such changes will be effected promptly, consistently, and pervasively throughout an enterprise, if appropriate. However, since the same business rule may be applicable in a variety of circumstances, it may be difficult to identify all affected computer applications, especially when business rules are embedded in computer applications. Additionally, it would be difficult, if possible at all, to understand the consequence of a deploying, modifying, or removing a business rule.

Business rules may relate to actual states of the business as reflected in data stored in one or more databases (e.g., databases 14) or other suitable storage modules, and to constraints on the changes in those states. Typically, business rules become relevant in the execution of a business process when some change of state of stored data is to occur that could violate a business rule. For example, these state changes may include the net changes that are reflected in a database or other storage module update, such as changes to the persistent state. Consequently, it may be appropriate or useful to invoke relevant business rules at appropriate points in business processes, such as when updates to stored data are being attempted.

The present invention applies relevant business rules (if any) at points in an automated business process when a step in the business process attempts to update data (e.g., data stored in one or more databases 14 or other suitable storage modules), which may help resolve one or more of the above-described problems in integrating business rules into one or more business processes. These automated business processes may be embedded in computer code, embedded in applications generated from models, and applications that execute process specifications (e.g., Business Process Management Systems). Typically, according to certain embodiments of the present invention, when a data update is initiated by a step in a business process, one or more relevant business rules (if any business rules are relevant) may be evaluated. This may help apply relevant business rules at appropriate points in computer applications that implement business processes without requiring that the business rules themselves be hard-coded into the computer applications. Throughout this description, integrating business rules into business processes includes deploying business rules in user system 12, executing business rules in user system 12, monitoring business rules in user system 12, modifying business rules in user system 12, and removing business rules from user system 12.

System 10 includes one or more user systems 12, primarily referred to throughout the remainder of this description in the singular as “user system 12.” User system 12 may be associated with a business enterprise. In certain embodiments, user system 12 and databases 14 are associated with the same enterprise; however, the present invention contemplates the enterprise with which user system 12 is associated being different from the enterprise with which one or more of databases 14 are associated. Users of user system 12 may include various employees of the enterprise, employees of a third party providing services to the enterprise (e.g., a consulting firm), or any other suitable users according to particular needs. User system 12 and users of user system 12 may be referred to interchangeably throughout this description.

User system 12 may include one or more computers at one or more locations, which may share data storage, communications, or other resources according to particular needs. For example, functionality described in connection with user system 12 may be provided using a single computer system, which in a particular embodiment might include a conventional desktop or laptop computer. For example, user system 12 may include a personal computer (PC), which in certain embodiments might include a desktop or laptop PC. Although a user system 12 is described primarily as a PC, the present invention contemplates user system 12 being any suitable type of computer system, according to particular needs. For example, user system 12 could include a client-server system. Furthermore, functionality described in connection with user system 12 may be provided using any suitable combination of software, firmware, and hardware. Each computer system of user system 12 may include one or more suitable input devices, output devices, mass storage media, processors, memory, or other components for receiving, processing, storing, and communicating information according to the operation of system 10.

A processing module 18 may include one or more processing units, which may include one or more microprocessors, controllers, or any other suitable computing devices or resources. Processing module 18 may work either alone or in combination with other components of user system 12 to provide the functionality of user system 12. For example, operations performed by processing module 18 may be performed collectively by processing module 18 and memory module 20.

System 10 may include or otherwise be associated with one or more memory modules 20. Each memory module 20 may take the form of volatile or non-volatile memory including, without limitation, magnetic media, optical media, random access memory (RAM), read-only memory (ROM), removable media, or any other suitable memory component. In certain embodiments, memory module 20 comprises one or more databases, such as one or more Structured Query Language (SQL) databases or any other suitable types of databases. Memory module 20 may be local to or remote from the one or more processing units 18 of user system 12.

User system 12 may comprise a business process management system, which may also be referred to as a workflow system. Thus, user system 12 may be operable to implement one or more business processes for its associated enterprise. Although a single user system 12 is illustrated, the present invention contemplates system 10 including any suitable number of user systems 12 according to particular needs. For example, in certain embodiments, system 10 includes multiple distributed user systems 12 that collectively form a business process management system. User systems 12 may be physically distributed, being in different physical locations geographically remote from each other, or logically distributed, being at approximately the same location as other user systems 12. Each user system 12 may operate using a different user platform, or two or more users systems 12 may operate using identical user platforms.

System 10 includes one or more databases 14. Databases 14 are operable to store data associated with the enterprise. In certain embodiments, databases 14 may each include one or more database tables 22 for storing one or more data elements. Each database 14 may include any memory or database module and may take the form of volatile or non-volatile memory including, without limitation, magnetic media, optical media, random access memory (RAM), read-only memory (ROM), removable media, or any other suitable local or memory component. In particular embodiments, databases 14 each include one or more SQL servers. Although a particular number of databases 14 is illustrated, system 10 may include any suitable number of databases 14 according to particular needs. Additionally, databases 14 may each be external or integral to other components of system 10.

Databases 14 may be heterogeneous, if appropriate. For example, databases 14 may include databases from different vendors, databases associated with different parts of the enterprise (e.g., one databases 14 associated with a Human Resources department, one database 14 associated with an Order Processing department, and one database 14 associated with an Accounting department), databases associated with different offices of the enterprise (e.g., one database 14 associated with a New York office of the enterprise and one database 14 associated with a London office of the enterprise), and databases that are heterogeneous in any other suitable way. Databases 14 may be local to or remote from one another and may be coupled to one another by a network or other suitable mechanism, if appropriate. Each database 14 is operable to process database operations in any suitable manner.

Network 16, which may couple user system 12 to databases 14, may include one or more local area networks (LANs), metropolitan area networks (MANs), wide area networks (WANs), radio access networks (RANs), a global computer network such as the Internet, or any other wireline, optical, wireless, or other links. Network 16 may communicate, for example, IP packets, Frame Relay frames, or Asynchronous Transfer Mode (ATM) cells to communicate voice, video, data, and other suitable information between network addresses. User system 12 may interact with databases 14 through network 16 (e.g., using applications 24, described below, or otherwise). The present invention contemplates any suitable intervening servers (e.g., one or more web servers) or other communication equipment (e.g., routers, switches, etc.) between user system 12 and databases 14.

User system 12 may include one or more applications 24, which may be implemented in any suitable combination of software, firmware, and hardware. Applications 20 may be written in any suitable language and may serve any suitable purpose. In certain embodiments, applications 24 assist employees or other individuals associated with the enterprise associated with system 10 in performing their jobs. For example, applications 24 may implement one or more business processes. Applications 24 may be client-server applications, web-based applications, applications that run solely on one or more users systems 12, or any other suitable types of applications.

In general, applications 24 provide users such as users of system 10 with the ability to execute one or more automated business processes, which may involve interacting with databases 14 or other storage modules, either directly or indirectly. For example, applications 24 may allow user system 12 to perform one or more data updates, such as one or more database operations on one or more of databases 14, during the course of executing an automated business process. For example, an automated business process implemented by one or more applications 24 may include a plurality of steps, one or more of which are operable to initiate a data update such as a database operation. Applications 24 may, either alone or through interaction with a user of user system 12, initiate database operations with respect to databases 14 or other suitable storage modules. For purposes of this description, a database operation may include adding data to one or more databases 14, modifying data stored in one or more databases 14, deleting data stored in one or more databases 14, or performing any other suitable operation with respect to one or more databases 14.

Certain data updates initiated by a step in an automated business process may affect one or more entities, one or more attributes of one or more entities, or both. An entity may include a cluster of data that represents the state of a person, place, or thing, including a conceptual thing, in the business. As non-limiting examples, an entity may include a cluster of data that represents the state of a customer, a part, an order, a specification, an account, a journal entry, or a driver's license. An attribute may include a characteristic of an entity, such as its name, color, weight, quantity, or status. An attribute may be an elementary data value, but an attribute may be a data structure when the characteristic is more complex. Such attributes may be managed substantially the same as attributes where a complex attribute is stored once and referenced by the relevant entities. In certain embodiments, entities may also have relationships with other entities. For example, an order may be related to the customer from whom the order is accepted. Entities (e.g., intersection or associative entities) may also represent the occurrence of a relationship where the relationship has additional attributes, such as where orders are associated with parts being ordered, and each association of “order” to “part” may have a quantity and potentially a price or weight. In certain embodiments, a relationship may be considered a special form of an attribute.

As described above, system 10 is operable to integrate business rules into one or more automated business processes (i.e., business processes implemented by applications 24) by applying relevant business rules (if any) such that when data updates (e.g., to data stored in one or more databases 14 or other suitable storage modules) are initiated by steps in a business process, one or more relevant business rules may be evaluated. Business rules may be expressed in any suitable manner, according to particular needs. It may be desirable for the business rules to be expressed in a substantially consistent manner. In certain embodiments, the rules in a shared rules repository (e.g., rule registry 26, described below) are stored and indexed in a consistent manner, so that they can be retrieved and evaluated by software that need not be specialized for different rules. For example, in certain embodiments, business rules may be expressed according to the Business Semantics of Business rules specification developed by the Object Management Group (OMG). Although this particular example is primarily described, business rules may be expressed in any suitable form.

In general, business rules may be defined as being relevant to one or more entities, to one or more attributes of one or more entities, or both. The entities and attributes that correspond to a business rule may be those entities and attributes that are relevant to whether the business rule would be violated if values for those entities and attributes are changed. In certain embodiments, a business rule corresponds to any suitable entity or attribute that may potentially violate the business rule if a data update that affects the entity or attribute is allowed to be performed. Moreover, in certain embodiments, changes in relationships among entities, or the addition or deletion of an entity, may form the basis of rule selection. For example, a data update affecting one or more entities or attributes may include a data update changing a relationship between or among entities. As described above, relationships may be considered a special form of an attribute. As another example, a data update affecting an entity may include a data update that adds or deletes the entity.

In certain embodiments, a method for integrating business rules into automated business processes comprises identifying an entity affected by a data update initiated by a step of an automated business process. The method further comprises accessing a rule registry comprising a plurality of business rules, each business rule corresponding to one or more entities, and determining which business rules in the rule registry to evaluate by determining from the plurality of business rules one or more business rules that correspond to the entity affected by the data update. The method further comprises, for each of the business rules determined to correspond to the entity affected by the data update, evaluating the business rule in context to determine whether performing the data update would violate the business rule and, if it is determined that performing the data update would violate the business rule, raising an exception in accordance with the violated business rule. In certain embodiments, further defining the business rules as corresponding to one or more attributes of an entity may provide more specificity in determining to which data updates the business rules are relevant.

As an example, a business rule may require that for a car rental agreement (a first entity) the renter (a second entity) have a valid driver's license. Thus, the business rule may be associated with at least two entities (i.e., the car rental agreement and the renter) and at least one attribute (i.e., the licensed status of the renter). In this example, the business rule may be evaluated if a data update generated by a step in the business process affects a car rental agreement, a renter, and the licensed status of the renter.

In certain embodiments, user system 12 comprises a rule registry 26. Rule registry 26 may be coupled to user system 12 in any suitable manner such that rule registry 26 is accessible (either directly or indirectly) to user system 12. For example, rule registry 26 may be stored in memory module 20, in a memory module (e.g., a database) coupled to user system 12, or in any other suitable storage module. Rule registry 26 may include information regarding a plurality of business rules 28 associated with system 10. Each business rule 28 may comprise rule information 30. Although rule registry 26 is described as including particular types of rule information 30 for each business rule 28, rule registry 26 may include any suitable information regarding each business rule 28, according to particular needs. For example, rule information 30 for a business rule 28 may include one or more of the following: (1) an algorithm for the business rule 28; (2) an identification of the one or more entities, one or more attributes of one or more entities, or both that correspond to the business rule 28; (3) the level of enforcement for the business rule 28 and possibly a disposition code indicating a type of action to be taken; (4) explanatory information regarding the business rule 28; (5) an explanation for the business rule 28; and (6) a rule expression for the business rule. At least certain of these are described in greater detail below.

Each business rule 28 may be associated with an algorithm for evaluating the business rule 28. In certain embodiments, the algorithm comprises an expression of a condition to be evaluated for the business rule 28. For example, a conditional expression for a business rule 28 may express a true-false or other binary condition indicating on what conditions a TRUE or FALSE value should be returned.

The identification of the one or more entities, one or more attributes of one or more entities, or both that correspond to the business rule 28 may include those entities and attributes that are relevant to the business rule 28. The granularity of this identification for a particular business rule 28 may depend on the whether one or more entities or both one or more entities and one or more attributes are defined as corresponding to the business rule 28. These identifications facilitate determining which business rules 28 to evaluate in response to a data update initiated by a step in a business process.

The enforcement level for a business rule 28 may include information for determining the appropriate action to be taken in response to determining that allowing a particular data update to be performed will violate one or more evaluated business rules 28. For example, the enforcement level for a business rule 28 may specify that, in response to determining that allowing a particular data update to be performed will violate one or more evaluated business rules 28, one or more of the following actions should be performed: (1) the particular data update should be denied; (2) an explanation for the determined violation of the business rule 28 should be provided; (3) the particular data update should be allowed, but special authorization is required; (4) the particular data update is allowed, but a process should be initiated to compensate for the consequences of the business rule 28 violation; (5) a notice of the determined violation is generated for monitoring; or (6) any other suitable action. Explanatory information regarding the business rule 28 may include a textual or other suitable statement that can be used to explain a determined violation of the business rule 28. The explanatory information may be used, for example, to provide a reason for the determined violation of a business rule 28 if required by the enforcement level of the business rule 28.

When a step in an automated business process attempts a data update (e.g., when an application 24 of user system 12 that implements all or a portion of a business process attempts to perform a data update such as a database operation with respect to a database 14), one or more business rules 28 may need to be evaluated if the entities and/or attributes that may be affected by the data update correspond to (e.g., match) the entities and/or attributes of one or more business rules 28. The entities and attributes that correspond to a business rule 28 are those entities and attributes that are relevant to whether the business rule 28 would be violated if values for those entities and attributes are changed. As described above, in certain embodiments, changes in relationships among entities, or the addition or deletion of an entity, may form the basis of rule 28 selection. In response to initiation of a data update by a step in an automated business process implemented by an application 24, the application 24 is operable to determine the one or more appropriate business rules 28 to evaluate based on the data update, evaluate the one or more appropriate business rules 28 to determine whether allowing the data update to be performed will violate any of the one or more business rules 28, and determine (e.g., if it is determined that allowing the data update to be performed will violate one or more of the evaluated business rules 28) an appropriate action to initiate for handling the determined violation. The application 24 may evaluate each of the business rules 28 that might be affected by the data update.

When a step in an automated business process implemented by application 24 generates a data update, application 24 may determine one or more of the entities and attributes that would be affected by a data update and determine one or more appropriate business rules 28 to evaluate based on the determined entities and attributes. For example, to determine the one or more business rules 28 to evaluate in response to the data update, application 24 may search rule registry 26 for business rules 28 that have rule information 30 identifying the entities and/or attributes identified for the data update. The one or more appropriate business rules 28 may include those business rules 28 that correspond to one or more of the entities or attributes that might be affected by the data update, which may be determined by accessing rule registry 26. For example, application 24 may select the business rules 28 that are defined in rule registry 26 as corresponding to at least the entities and/or attributes that may be affected by the data update.

Application 24 may evaluate the one or more appropriate business rules 28 to determine whether allowing the data update to be performed will violate any of the one or more appropriate business rules 28. In certain embodiments, for each of the appropriate business rules 28, application 24 may process the rule algorithm for the business rule 28. Application 24 may access rule information 30 for each of the appropriate business rules 28 to determine the algorithm for the business rule 28.

Based on the determination of whether a data update will violate any appropriate business rule 28 if the data update is allowed to be performed, application 24 may determine the consequences of the violation determination. For example, if application 24 determines that allowing the data update to be performed will violate one or more of the evaluated business rules 28, application 24 may raise an exception in accordance with the violated business rule 28. For example, application 24 may determine an appropriate action to initiate for handling the determined violation. In certain embodiments, the appropriate action may be determined based on the rule information 30 for the one or more relevant business rules 28, such as the enforcement level of the business rule 28 that will be violated if the database operation is allowed to be performed. Example actions that may be performed if it is determined that the database operation will violate one or more business rules 28 if the database operation is allowed to be performed are described in more detail below.

User system 12 may comprise one or more caches 32, which may comprise any suitable type of memory. In certain embodiments, business rules 28 determined to be relevant may be stored in cache 32, so that those business rules 28 may be more easily accessed during execution of a business process. For example, the first time a particular step in a business process is executed, one or more particular business rules 28 in rule registry 26 may be determined to be relevant to the particular step. The executing application 24 (or another suitable component of user system 12) may initiate storage of the one or more particular business rules 28 in cache 32, so that if and when the particular step in the business process is repeated, the same one or more particular business rules 28 may be applied. In certain embodiments, even though the one or more particular business rules 28 are stored in cache 32, the determination of relevant business rules 28 may be repeated if, for example, a subsequent execution of the particular step of the business process affects additional or different entities or attributes. As another example, if business rules 28 are added or changed in rule registry 26, it may be appropriate to update cache 32. In certain embodiments, updating cache 32 may include “flushing” or “purging” cache 32, or tracking affected entities or attributes for each cache 32. In such embodiments, caches 32 may only be updated with new business rules 28 that depend on the affected entities or attributes for each cache 32.

In certain embodiments, mapping information 34 may be stored. Mapping information 36 may be used to track the association of business rules 28 with steps in automated business processes. This may allow reports of associations between business process steps and business rules 28 to be generated. This may also allow business rules 28 to be “report only” such that when the business rules 28 are violated, the violation is reported but the data update is allowed to be performed. Report-only business rules 28 may allow analysis of the potential impact of a business rule 28 prior to making the business rule 28 effective in production. Mapping information 36 may be stored in any suitable memory module of system 10, according to particular needs.

In operation of an example embodiment of system 10, a business rule 28 may be deployed within system 10. The business rule 28 may be deployed at build time, at run time, or at any other suitable time according to particular needs. Although deploying a single business rule 28 is primarily described, the present invention contemplates deploying multiple business rules 28.

A business rule 28 to be deployed may be defined. For example, a business rule 28 may be defined by reviewing government regulations for a particular business practice. As another example, a business rule 28 may be defined by one or more managers. As another example, a business rule 28 may be defined by reviewing and/or identifying one or more best practices of an enterprise. As another example, a business rule 28 may be defined through tracking a business rule 28 that has been implemented with notification only so that the occurrence of violations of the business rule 28 can be monitored and the impact evaluated. In certain embodiments, implementing a business rule 28 with monitoring only may allow the defined business rule 28 to be tailored prior to its actual enforcement within system 10. Although particular example techniques for defining a business rule 28 for deployment have been described, business rules 28 may be defined for deployment in any suitable manner, according to particular needs.

The defined business rule 28 may be expressed in an appropriate form. In certain embodiments, the defined business rule 28 may be expressed in a standard form. The standard form may be an industry standard form, such as the form provided by the Business Semantics of Business rules 28 specification defined by the OMG. Although expressing the defined business rule 28 in a standard form is primarily described, business rules 28 may be expressed in any suitable manner, according to particular needs. In certain embodiments, business rules 28 may be expressed in a consistent form relative to one another in rule registry 26 for retrieval and evaluation.

One or more entities, one or more attributes of one or more entities, or both that correspond to the business rule 28 may be identified. The business rule 28 may be defined to correspond to the one or more identified entities and attributes. Depending on the level of granularity desired, a business rule 28 may be defined to correspond to one or more entities or to both one or more entities and one or more attributes of the one or more entities. Rule registry 26 may be updated with rule information 30 for the business rule 28 being deployed. In certain embodiments, rule information 30 includes one or more of the following: an algorithm for evaluating the business rule 28; an identification of the one or more entities, one or more attributes of one or more entities, or both that correspond to the business rule 28; the level of enforcement for the business rule 28; explanatory information regarding the business rule 28; an explanation for the business rule 28; and a rule expression for the business rule.

Application 24 or another suitable component of user system 12 may determine whether cache 32 should be purged or updated as part of the deployment of the business rule 28. For example, if the business rule 28 or information defining the business rule 28 is stored in cache 32, it may be determined that cache 32 should be purged or updated. If it is determined that cache 32 should be purged or updated, then application 24 or another suitable component of user system 12 may purge or update cache 32 in any suitable manner.

In operation of an example embodiment of system 10, business rules 28 may be removed from system 10. The business rule 28 may be removed at build time, at run time, or at any other suitable time according to particular needs. Although removing a single business rule 28 is primarily described, the present invention contemplates removing multiple business rules 28.

A business rule 28 to be removed is identified. For example, a business rule 28 may be identified by one or more managers. As another example, a business rule 28 may be identified through tracking of a business rule 28. The occurrence of violations of the business rule 28 may be monitored (e.g., through the use of notifications), for example, to determine the frequency and circumstances of the rule violations and to determine the affected organizations. If appropriate, the business rule 28 may be changed to support monitoring only. Although particular example techniques for identifying a business rule 28 for removal have been described, business rules 28 may be identified for removal in any suitable manner, according to particular needs.

Rule registry 26 may be updated to remove rule information 30 for the business rule 28 being removed. In certain embodiments, rule information 30 for the business rule 28 being removed is not deleted, but is flagged in some way to indicate that it is not active with respect to any business rule 28. For example, the portion of rule information 30 identifying the one or more entities and attributes to which the business rule 28 corresponds may be blank, such that the business rule 28 will not be evaluated for any data update.

Application 24 or another suitable component of user system 12 may determine whether cache 32 should be purged as part of the removal of the identified business rule 28. For example, if the identified business rule 28 or information identifying the identified business rule 28 is stored in cache 32, it may be determined that cache 32 should be purged. If it is determined that the cache should be purged, then application 24 or another suitable component of user system 12 may purge cache 32 in any suitable manner.

In operation of an example embodiment of system 10, one or more business rules 28 may be executed, at run time for example. A step in an automated business process executing on user system 12 may generate a data update. For example, an application 24 that implements the business process may generate the data update. As described above, the data update may be a database operation, such as a request to add data to one or more databases 14, a request to modify data stored in one or more databases 14, a request to delete data stored in one or more databases 14, or a request to perform any other suitable operation with respect to one or more databases 14. The data update may include any other suitable type of data addition, modification, or removal with respect to data in any other suitable storage module.

Application 24 may identify the one or more entities, one or more attributes of one or more entities, or both that may be affected by the data update initiated by the step in the business process executing on user system 12. For example, application 24 may, in response to the data update, determine the one or more entities and attributes that may be affected if the data update is allowed to be performed. In certain embodiments, determining one or more attributes that may be affected by the data update, in addition to determining one or more entities that may be affected by the data update, may provide additional specificity in identifying the appropriate business rules 28 to evaluate.

Application 24 or another suitable component of system 10 may determine whether the business rules 28 relevant to the step of the business process that generated the data update are stored in cache 32 of user system 12. If it is determined that the business rules 28 relevant to the step of the business process that generated the data update are stored in cache 32 of user system 12, then the relevant business rules 28 stored in cache 32 may be evaluated. If it is determined that the business rules 28 relevant to the step of the business process that generated the data update are not stored in cache 32 of user system 12, then, as described below, the plurality of business rules 28 may be accessed to determine the one or more relevant business rules 28 (if any). In addition to the relevant business rules 28 not being stored in cache 32, the relevant business rules 28 may need to be determined anew (even if certain relevant business rules 28 are stored in cache 32) if, for example, the data update may affect additional entities or attributes or if additional business rules 28 have been introduced.

Application 24 may access the plurality of business rules 28 (e.g., rule registry 26), each of which may correspond to one or more entities or both to one or more entities and one or more attributes of the one or more entities. Application 24 may determine which business rules 28 in rule registry 26 (if any) to evaluate by determining from the plurality of business rules 28 one or more business rules 28 that correspond to the one or more entities that may be affected by the data update, the one or more attributes that may be affected by the data update, or both.

Application 24 may determine which rules to evaluate based on rule information 30. For example, rule information 30 of each business rule 28 in rule registry 26 may include an identification of the entities and attributes that correspond to the business rule 28. Application 24 may compare this rule information 30 to the one or more identified entities and/or the one or more identified attributes that may be affected by the data update to determine whether a business rule 28 should be evaluated. In such embodiments, multiple business rules 28 may be evaluated based on a single request. For example, rule information 30 for multiple business rules 28 may indicate that those business rules 28 correspond to some or all of the same entities and attributes as those entities and attributes that may be affected by the data update. Thus, in certain embodiments, each of these business rules 28 may be evaluated by application 24.

Application 24 or another suitable component of user system 12 may determine whether to store in cache 32 the one or more business rules 28 determined to correspond to the same entities and attributes as the step in the business process that generated the data update. If it is determined that the determined business rules 28 should be stored in cache 32, then application 24 or another suitable component of user system 12 may initiate storage of the determined business rules 28 in cache 32. If it is determined that the determined business rules 28 should not be stored in cache 32, then application 24 may evaluate in context the one or more business rules 28 determined to correspond to the entity or attributes affected by the data update to determine whether allowing the data update to be performed will violate any of the one or more business rules 28. For example, application 24 may evaluate an appropriate business rule 28 by evaluating the algorithm for the business rule 28, as specified in rule information 30 for the business rule 28.

Evaluating a business rule 28 in context may include evaluating the business rule 28 in real time at a point in an automated business process where the business rule 28 is relevant, using any appropriate parameters. As described above, retrieval of business rules 28 to be evaluated is based on the one or more entities and/or attributes that may be affected by a data update. A business rule 28 may reference additional entities and/or attributes beyond those that may be affected by a particular data update. Evaluating the business rule in context of application 24 may allow the business rule 28 to have access to entities and/or attributes that have not been (or will not be) changed, but that may be relevant to the condition being evaluated by application 24 when evaluating the business rule 28.

Application 24 may determine whether one or more evaluated business rules 28 will be violated if the data update is allowed to be performed. If application 24 determines that a business rule 28 will not be violated if the requested data update is allowed to be performed, then application 24 may allow the data update to occur. The present invention contemplates any suitable technique for handling non-violations of business rules 28. For example, a notification may be sent to one or more appropriate individuals indicating that a particular business rule 28 was evaluated and no violation was determined. As another example, certain details associated with the evaluation of the business rule 28 may be logged for its statistical value.

If application 24 determines that a business rule 28 will be violated if the requested data update is allowed to be performed, application 24 may raise an exception in accordance with the violated business rule 28. For example, application 24 may determine an appropriate action to initiate for handling the determined violation. In certain embodiments, the appropriate action may be determined based on the rule information 30 for the one or more relevant business rules 28, such as the enforcement level of the business rule 28 that will be violated if the database operation is allowed to be performed. Application 24 may initiate or perform any number of appropriate actions, either alone or in combination, which may be referred to as raising an exception in accordance with the business rule 28.

For example, application 24 may generate a violation code or other suitable identifier indicating that a violation will occur if the requested data update is allowed to be performed. As another example, application 24 may generate an explanation for the determined rule violation. In certain embodiments, this explanation may be based on rule information 30 for the violated business rule 28, including for example the explanatory information regarding the violated business rule 28. As another example, application 24 may deny the data update.

As another example, application 24 may determine that the data update should be allowed, but only with special authorization. This authorization may include, for example, the authorization of a manager or other appropriate individual of sufficient authority. As another example, application 24 may determine that the data update should be allowed, but that a process should be initiated to compensate for the consequences of the determined business rule violation. As another example, application 24 may generate or initiate generation of a notification of the business rule 28 violation. The notification may be in any suitable format and may include any suitable information, according to particular needs. The notification may be used to initiate an appropriate action, to support monitoring, or for any other suitable purpose. Although violation of a single rule has been primarily described, a requested data update could violate multiple rules. In such embodiments, application 24 may initiate any number of suitable actions according to each of the determined violations or it may evaluate one rule based on a determination of priority.

Applications 24 may handle rule violations in any suitable manner, according to particular needs. In certain embodiments, application 24 is operable to perform certain exception processing. In such embodiments, if application 24 determines that a violation of a business rule 28 has been determined for a data update, application 24 may handle this indication in any suitable manner, based on the built-in exception processing of application 24.

In certain embodiments, a violation table may be added to user system 12 to identify transactions (e.g., business process steps or data updates) that violated a business rule 28, the reason for each violation, and any other suitable information. When a violation occurs and the data update is denied, the violation table may be referenced by application 24 to determine the reason the data update was denied. In such embodiments, application 24 may access the violation table to determine if a rule violation has occurred in situations in which the data update was not denied. In certain embodiments, application 24 may generate a notification. In certain embodiments, the notification may be an asynchronous message, although the present invention contemplates the notification having any suitable format according to particular needs. This approach may be useful for monitoring. In this example, it may be helpful for a determined violation for a data update to be handled through corrective action after the data update is allowed. The above-described example techniques for handling rule violations may be used alone or in combination.

In certain embodiments, application 24 may initiate storage of information regarding determined violations of business rules 28. For example, application 24 may store information regarding determined violations of business rules 28 in a database or other suitable memory module. The information stored regarding the determined violations of business rules 28 may include an identification of the business rule 28 violated, the number of times the business rule 28 was violated, the explanatory information for the violation (e.g., based on rule information 30 for the violated business rule 28), the date and time of the violation, the data update or business process step that resulted in the violation, or any other suitable information. The information regarding the determined violations of business rules 28 may be stored if action is delayed as a result of violation of the business rule 28 or at any other suitable time, according to particular needs. The explanatory information regarding the business rule 28 may be included in the stored information so that a reviewer of the stored information can identify the business rule 28 and the meaning of the violation of the business rule 28.

In certain embodiments, system 10 supports various procedures for implementing business rules 28 that incorporate certain monitoring of a business rule 28 to determine the proper or desired implementation of the business rules 28. For example, a new business rule 28 may be defined that the management of the enterprise associated with system 10 would like to deploy throughout the enterprise. It may be useful to deploy the business rule 28 without any hard exceptions. For example, it may be desirable to deploy the business rule 28 such that when a violation of the business rule 28 is determined, the data update that caused the determined violation is allowed to be performed, but a notification that the data update violated one or more business rules 28 is generated. This may allow users associated with system 10 to determine certain statistical information associated with the new business rule 28. For example, the statistical information may include where the business rule 28 is violated (e.g., from which user systems 12 data updates that violate the business rule 28 are generated), how often the business rule 28 is violated, or any other suitable statistical or audit information. In certain embodiments, an informed decision may then be made, based on this statistical information, regarding how or whether the business rule 28 should be enforced (e.g., the level of enforcement for the business rule 28). As a particular example, the enforcement level of the business rules 28 may be altered to include certain actions initiated if one of the business rules 28 is violated. As another example, these monitoring techniques may be used for determining whether to remove or modify existing business rules 28.

In operation of an example embodiment of system 10, a business rule 28 may be implemented with notification only so that the occurrence of determined violations can be monitored and the impact evaluated. In certain embodiments, notification messages, such as emails, text messages, communications sent to a pager device, or any other suitable notification may be generated and delivered to suitable personnel such as the organization responsible for business rule 28 violations. The recipients may initiate corrective action and provide feedback on the effects of the business rule 28. Based on the feedback received, one or more applications 24 may be updated to automate appropriate action in response to a determined violation of the business rule 28. This methodology may allow a business rule 28 to be monitored, evaluated, and tailored based upon feedback received through actual implementation of the business rule 28.

In certain embodiments, system 10 supports various procedures for removing one or more business rules 28 that incorporate tracking the implemented rules. In operation of an example embodiment of system 10, the occurrence of determined business rule 28 violations may be monitored (e.g., through the use of notifications) to determine the frequency and circumstances of the rule violations and to determine the affected organizations. The monitoring may be changed to report determined violations to the responsible organizations, so that the impact of a modification to a business rule 28 can be evaluated by those responsible for the business process at issue. The business rule 28 may be changed to support monitoring only. For example, the business rule information 30 in rule registry 26 may be changed to only require notifications in response to the rule violations for that business rule 28.

Although the components of system 10 are described as separate, the present invention contemplates omitting certain components, combining certain components, or other variations without departing from the spirit and scope of the present invention. For example, as described briefly above, the present invention contemplates system 10 not including server system 14 and user systems 12 interacting directly with databases 14, if appropriate.

Moreover, although applications 24 have been primarily described as performing, in response to a data update, the determination of whether to evaluate one or more business rules 28, the determination of which business rules 28 to evaluate, and the evaluation of those determined business rules 28, the present invention is not intended to be limited to such embodiments. For example, it may be appropriate for a layer between applications 24 and the database management system of databases 14 to perform one or more of these functions. As a particular example, applications may be deployed in a framework, container, or other environment that provides basic functionality common to two or more applications 24. An object-oriented application, for example, may have software that intervenes between the application and a database to transform the object structures to relational database structures. This intervening software may be referred to as common data access management software. In certain embodiments, this intervening software may, in response to a data update by an application 24, determine whether to evaluate one or more business rules 28, determine which business rules 28 to evaluate, and evaluate those determined business rules 28, which may relieve application developers of the burden of directly addressing the retrieval and evaluation of business rules 28.

Particular embodiments of the present invention may provide one or more technical advantages. In certain embodiments, the present invention may enable consistent application of business rules 28 throughout an enterprise. In certain embodiments, the present invention organizes or indexes business rules 28 that describe the bounds of acceptable operation of the enterprise, so that business rules 28 can be evaluated with respect to updates to data relating to particular entities and attributes. In certain embodiments, the present invention allows general rules 28 that are potentially applicable across multiple business processes or contexts to be evaluated at appropriate points in a controlled, reliable way. In certain embodiments, the present invention enables business rules 28 to be evaluated “in context.” In certain embodiments, the present invention provides a mechanism for monitoring violations of business rules 28 such as the generation of an event notification when a violation is detected. Moreover, the detection of a violation of a business rule 28 may result in the initiation of one or more processes.

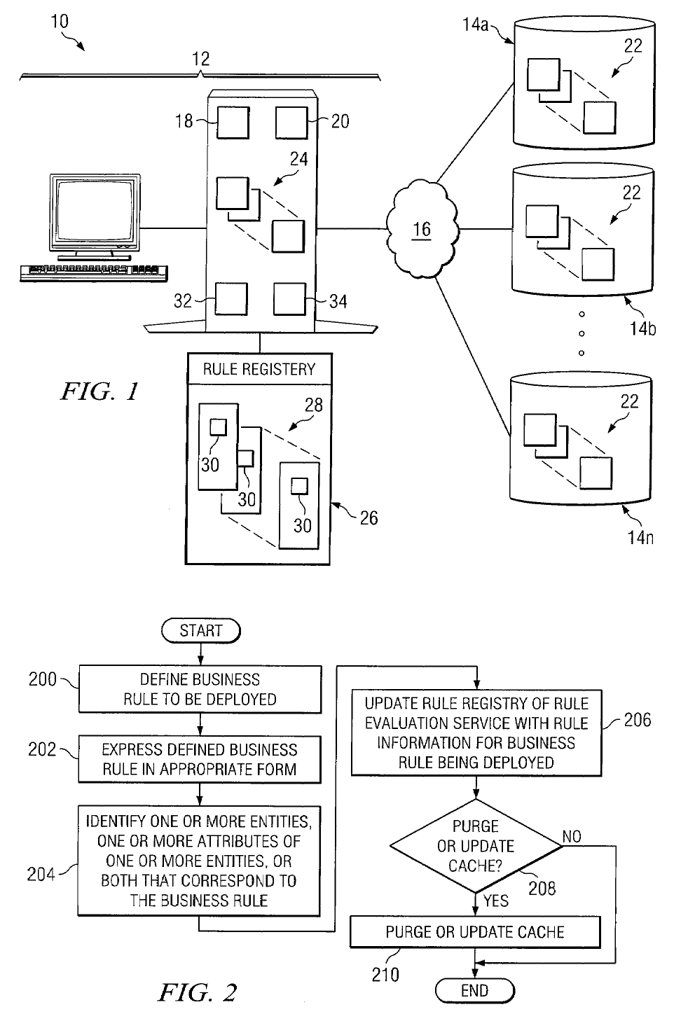

FIG. 2 illustrates an example method for deploying a business rule 28 according to certain embodiments of the present invention. The business rule 28 may be deployed at build time, at run time, or at any other suitable time according to particular needs. Although deploying a single business rule 28 is primarily described with reference to FIG. 2, the present invention contemplates deploying multiple business rules 28.

At step 200, a business rule 28 to be deployed may be defined. For example, a business rule 28 may be defined by reviewing government regulations for a particular business practice. As another example, a business rule 28 may be defined by one or more managers. As another example, a business rule 28 may be defined by reviewing and/or identifying one or more best practices of an enterprise. As another example, a business rule 28 may be defined through tracking a business rule 28 that has been implemented with notification only so that the occurrence of violations of the business rule 28 can be monitored and the impact evaluated. In certain embodiments, implementing a business rule 28 with monitoring only may allow the defined business rule 28 to be tailored prior to its actual enforcement within system 10. Although particular example techniques for defining a business rule 28 for deployment have been described, business rules 28 may be defined for deployment in any suitable manner, according to particular needs.

At step 202, the defined business rule 28 may be expressed in an appropriate form. In certain embodiments, the defined business rule 28 may be expressed in a standard form. The standard form may be an industry standard form, such as the form provided by the Business Semantics of Business rules 28 specification defined by the OMG. Although expressing the defined business rule 28 in a standard form is primarily described, business rules 28 may be expressed in any suitable manner, according to particular needs. In certain embodiments, business rules 28 may be expressed in a consistent form relative to one another in rule registry 26 for retrieval and evaluation.

At step 204, one or more entities, one or more attributes of one or more entities, or both that correspond to the business rule 28 may be identified. The business rule 28 may be defined to correspond to the one or more identified entities and attributes. Depending on the level of granularity desired, a business rule 28 may be defined to correspond to one or more entities or to both one or more entities and one or more attributes of the one or more entities. At step 206, rule registry 26 may be updated with rule information 30 for the business rule 28 being deployed. In certain embodiments, rule information 30 includes one or more of the following: an algorithm for evaluating the business rule 28; an identification of the one or more entities, one or more attributes of one or more entities, or both, that correspond to the business rule 28; the level of enforcement for the business rule 28; explanatory information regarding the business rule 28; an explanation for the business rule 28; and a rule expression for the business rule.

At step 208, application 24 or another suitable component of user system 12 may determine whether cache 32 should be purged or updated as part of the deployment of the business rule 28. For example, if the business rule 28 or information defining the business rule 28 is stored in cache 32, it may be determined that cache 32 should be purged or updated. If it is determined at step 208 that cache 32 should be purged or updated, then at step 210 application 24 or another suitable component of user system 12 may purge or update cache 32 in any suitable manner. If it is determined at step 208 that cache 32 should not be purged or updated, then the method may end.

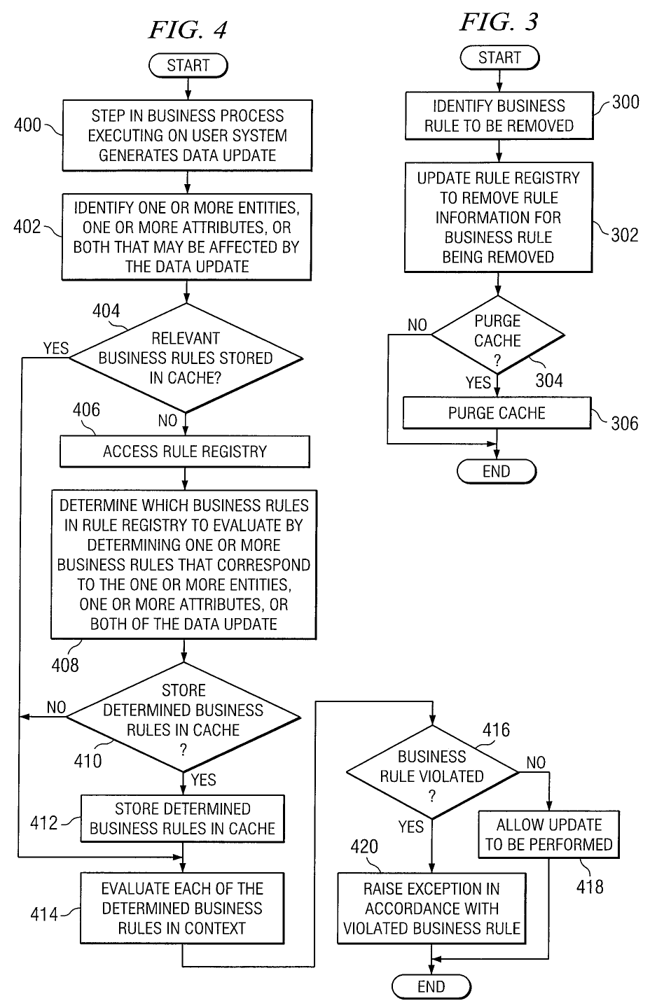

FIG. 3 illustrates an example method for removing a business rule 28 according to certain embodiments of the present invention. The business rule 28 may be removed at build time, at run time, or at any other suitable time according to particular needs. Although removing a single business rule 28 is primarily described with reference to FIG. 3, the present invention contemplates removing multiple business rules 28.

At step 300, a business rule 28 to be removed is identified. For example, a business rule 28 may be identified by one or more managers. As another example, a business rule 28 may be identified through tracking of a business rule 28. The occurrence of violations of the business rule 28 may be monitored (e.g., through the use of notifications), for example, to determine the frequency and circumstances of the rule violations and to determine the affected organizations. If appropriate, the business rule 28 may be changed to support monitoring only. Although particular example techniques for identifying a business rule 28 for removal have been described, business rules 28 may be identified for removal in any suitable manner, according to particular needs.

At step 302, rule registry 26 may be updated to remove rule information 30 for the business rule 28 being removed. In certain embodiments, rule information 30 for the business rule 28 being removed is not deleted, but is flagged in some way to indicate that it is not active with respect to any business rule 28. For example, the portion of rule information 30 identifying the one or more entities and attributes to which the business rule 28 corresponds may be blank, such that the business rule 28 will not be evaluated for any data update.

At step 304, application 24 or another suitable component of user system 12 may determine whether cache 32 should be purged as part of the removal of the identified business rule 28. For example, if the identified business rule 28 or information identifying the identified business rule 28 is stored in cache 32, it may be determined that cache 32 should be purged. If it is determined at step 304 that cache 32 should be purged, then at step 306 application 24 or another suitable component of user system 12 may purge cache 32 in any suitable manner. If it is determined at step 304 that cache 32 should not be purged, then the method may end.

FIG. 4 illustrates an example method for executing one or more business rules 28 according to certain embodiments of the present invention. In certain embodiments, the one or more business rules 28 may be executed at run time.

At step 400, a step in an automated business process executing on user system 12 may generate a data update. For example, an application 24 that implements the business process may generate the data update. As described above, the data update may be a database operation, such as a request to add data to one or more databases 14, a request to modify data stored in one or more databases 14, a request to delete data stored in one or more databases 14, or a request to perform any other suitable operation with respect to one or more databases 14. The data update may include any other suitable type of data addition, modification, or removal with respect to data in any other suitable storage medium.

At step 402, application 24 may identify the one or more entities, one or more attributes of one or more entities, or both that may be affected by the data update initiated by the step in the business process executing on user system 12. For example, application 24 may, in response to the data update, determine the one or more entities and attributes that may be affected if the data update is allowed to be performed. In certain embodiments, determining one or more attributes that may be affected by the data update, in addition to determining one or more entities that may be affected by the data update, may provide additional specificity in identifying the appropriate business rules 28 to evaluate.

At step 404, application 24 or another suitable component of system 10 may determine whether the business rules 28 relevant to the step of the business process that generated the data update are stored in cache 32 of user system 12. If it is determined at step 404 that the business rules 28 relevant to the step of the business process that generated the data update are stored in cache 32 of user system 12, then the method may proceed to step 414 (described below) to evaluate the relevant business rules 28 stored in cache 32. If it is determined at step 404 that the business rules 28 relevant to the step of the business process that generated the data update are not stored in cache 32 of user system 12, then the method may proceed to step 406. In addition to the relevant business rules 28 not being stored in cache 32, the relevant business rules 28 may need to be determined anew (even if certain relevant business rules 28 are stored in cache 32) if, for example, the data update may affect additional entities or attributes or if additional business rules 28 have been introduced.

At step 406, application 24 may access the plurality of business rules 28 (e.g., rule registry 26), each of which may correspond to one or more entities or both to one or more entities and one or more attributes of the one or more entities. At step 408, application 24 may determine which business rules 28 in rule registry 26 (if any) to evaluate by determining from the plurality of business rules 28 one or more business rules 28 that correspond to the one or more entities that may be affected by the data update, the one or more attributes that may be affected by the data update, or both.

Application 24 may determine which rules to evaluate based on rule information 30. For example, rule information 30 of each business rule 28 in rule registry 26 may include an identification of the entities and attributes that correspond to the business rule 28. Application 24 may compare this rule information 30 to the one or more identified entities and/or the one or more identified attributes that may be affected by the data update to determine whether a business rule 28 should be evaluated. In such embodiments, multiple business rules 28 may be evaluated based on a single request. For example, rule information 30 for multiple business rules 28 may indicate that those business rules 28 correspond to some or all of the same entities and attributes as those entities and attributes that may be affected by the data update. Thus, in certain embodiments, each of these business rules 28 may be evaluated by application 24.

At step 410, application 24 or another suitable component of user system 12 may determine whether to store in cache 32 the one or more business rules 28 determined to correspond to the same entities and attributes as the step in the business process that generated the data update. If it is determined at step 410 that the determined business rules 28 should be stored in cache 32, then at step 412, application 24 or another suitable component of user system 12 may initiate storage of the determined business rules 28 in cache 32. If it is determined at step 410 that the determined business rules 28 should not be stored in cache 32, then the method may proceed to step 414.

At step 414, application 24 may evaluate in context the one or more business rules 28 determined to correspond to the entity or attributes affected by the data update to determine whether allowing the data update to be performed will violate any of the one or more business rules 28. For example, application 24 may evaluate an appropriate business rule 28 (e.g., a business rule 28 determined to be appropriate at step 408) by evaluating the algorithm for the business rule 28, as specified in rule information 30 for the business rule 28.

Evaluating a business rule 28 in context may include evaluating the business rule 28 in real time at a point in a business process where the business rule 28 is relevant, using any appropriate parameters. As described above, retrieval of business rules 28 to be evaluated is based on the one or more entities and/or attributes that may be affected by a data update. A business rule 28 may reference additional entities and/or attributes beyond those that may be affected by a particular data update. Evaluating the business rule in context of application 24 may allow the business rule 28 to have access to entities and/or attributes that have not (or will not be) changed, but that may be relevant to the condition being evaluated by application 24 when evaluating the business rule 28.

At step 416, application 24 may determine whether one or more evaluated business rules 28 will be violated if the data update is allowed to be performed. Although steps 414 and 416 are described separately, in certain embodiments, steps 414 and 416 may be performed as essentially a single step.

If application 24 determines at step 416 that a business rule 28 will not be violated if the requested data update is allowed to be performed, then at step 418 application 24 may allow the data update to occur. The present invention contemplates any suitable technique for handling non-violations of business rules 28. For example, a notification may be sent to one or more appropriate individuals indicating that a particular business rule 28 was evaluated and no violation was determined. As another example, certain details associated with the evaluation of the business rule 28 may be logged for its statistical value.

If application 24 determines at step 416 that a business rule 28 will be violated if the requested data update is allowed to be performed, then at step 420 application 24 may initiate or perform any number of appropriate actions, either alone or in combination, which may be referred to as raising an exception in accordance with the business rule 28. Application 24 may determine the appropriate action to initiate or perform based on rule information 30 for the one or more violated business rules 28, including for example the level of enforcement for the one or more violated business rules 28.

For example, application 24 may generate a violation code or other suitable identifier indicating that a violation will occur if the requested data update is allowed to be performed. As another example, application 24 may generate an explanation for the determined rule violation. In certain embodiments, this explanation may be based on rule information 30 for the violated business rule 28, including for example the explanatory information regarding the violated business rule 28. As another example, application 24 may deny the data update.

As another example, application 24 may determine that the data update should be allowed, but only with special authorization. This authorization may include, for example, the authorization of a manager or other appropriate individual of sufficient authority. As another example, application 24 may determine that the data update should be allowed, but that a process should be initiated to compensate for the consequences of the determined business rule 28 violation. As another example, application 24 may generate or initiate generation of a notification of the business rule 28 violation. The notification may be in any suitable format and may include any suitable information, according to particular needs. The notification may be used to initiate an appropriate action, to support monitoring, or for any other suitable purpose. Although violation of a single rule has been primarily described, a requested data update could violate multiple rules. In such embodiments, application 24 may initiate any number of suitable actions according to each of the determined violations.

In certain embodiments, application 24 may initiate storage of information regarding determined violations of business rules 28. For example, application 24 may store information regarding determined violations of business rules 28 in a database or other suitable memory module. The information stored regarding the determined violations of business rules 28 may include an identification of the business rule 28 violated, the number of times the business rule 28 was violated, the explanatory information for the violation (e.g., based on rule information 30 for the violated business rule 28), the date and time of the violation, the data update or business process step that resulted in the violation, or any other suitable information. The information regarding the determined violations of business rules 28 may be stored if action is delayed as a result of violation of the business rule 28 or at any other suitable time, according to particular needs. The explanatory information regarding the business rule 28 may be included in the stored information so that a reviewer of the stored information can identify the business rule 28 and the meaning of the violation of the business rule 28.

Although particular methods have been described with reference to FIGS. 2-4, the present invention contemplates any suitable methods in accordance with the present invention. Thus, certain of the steps described with reference to FIGS. 2-4 may take place substantially simultaneously and/or in different orders than as shown and described. Moreover, components of system 10 may use methods with additional steps, fewer steps, and/or different steps, so long as the methods remain appropriate.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for integrating business rules into automated business processes, comprising:
identifying an entity affected by a data update initiated by a step of an automated business process;
accessing a rule registry comprising a plurality of business rules, each business rule corresponding to one or more entities;
determining which business rules in the rule registry to evaluate by determining from the plurality of business rules one or more business rules that correspond to the entity affected by the data update;
for each of the business rules determined to correspond to the entity affected by the data update:
evaluating the business rule in context to determine whether performing the data update would violate the business rule; and
if it is determined that performing the data update would violate the business rule, raising an exception in accordance with the violated business rule.

2. The method of claim 1, wherein:
for each of the one or more entities to which a business rule corresponds, the business rule further corresponds to one or more attributes of the entity; and
the method further comprises:
determining for the entity affected by the data update one or more attributes affected by the data update;
determining which business rules in the collection of business rules to evaluate by determining from the plurality of business rules one or more business rules that correspond both to the entity affected by the data update and to the one or more attributes affected by the data update.

3. The method of claim 1, wherein the step of the business process is one of a plurality of steps of the business process, one or more of the plurality of steps operable to initiate a data update.

4. The method of claim 1, further comprising tracking which business rules are evaluated for the step in the business process by storing an association of the evaluated business rules with the step in the business process.

5. The method of claim 1, wherein each business rule comprises rule information comprising one or more of the following:
an explanation for the business rule;
a rule expression for the business rule;
an algorithm for the business rule;
an identification of one or more entities that correspond to the business rule;
an identification of one or more attributes that correspond to the business rule; and
a level of enforcement for the business rule.

6. The method of claim 1, comprising storing the one or more evaluated business rules in a cache such that if the step of the business process is executed at a future time, the one or more business rules may be retrieved from the cache.

7. The method of claim 1, comprising determining, if it is determined that performing the data update will violate a particular one of the one or more business rules that correspond to the entity affected by the data update, the appropriate action to initiate for handling the determined violation based on a level of enforcement for the particular business rule.

8. The method of claim 7, wherein the appropriate action comprises one or more of the following:
returning a violation code;
returning an explanation for the violation of the business rule;
returning an indication that the data update should be allowed, but that special authorization is required;
returning an indication that the data update should be allowed, but that a process should be initiated to compensate for the consequences of the violation;
communicating a notification of the violation; and
recording information about the violation for analysis or audit.

9. The method of claim 1, comprising, if it is determined that performing the data update would violate the business rule:
reporting the violation of the business rule; and
allowing the data update to be performed.

10. The method of claim 1, comprising:
if it is determined that performing the data update would not violate the business rule, allowing the data update to be performed; and
if it is determined that performing the data update would violate the business rule, preventing the data update from being performed.

11. The method of claim 1, wherein the data update comprises one or more of:
a request to add data to one or more storage mediums;
a request to modify data stored in one or more storage mediums; and
a request to delete data stored in one or more storage mediums.

12. A system for integrating business rules into automated business processes, comprising:
a rule registry operable to store a plurality of business rules, each business rule corresponding to one or more entities;
one or more processing units operable to:
identify an entity affected by a data update initiated by a step of an automated business process;
access the rule registry comprising the plurality of business rules;
determine which business rules in the rule registry to evaluate by determining from the plurality of business rules one or more business rules that correspond to the entity affected by the data update;
for each of the business rules determined to correspond to the entity affected by the data update:
evaluate the business rule in context to determine whether performing the data update would violate the business rule; and
if it is determined that performing the data update would violate the business rule, raise an exception in accordance with the violated business rule.

13. The system of claim 12, wherein:
for each of the one or more entities to which a business rule corresponds, the business rule further corresponds to one or more attributes of the entity; and
the one or more processing units are further operable to:
determine for the entity affected by the data update one or more attributes affected by the data update;
determine which business rules in the collection of business rules to evaluate by determining from the plurality of business rules one or more business rules that correspond both to the entity affected by the data update and to the one or more attributes affected by the data update.

14. The system of claim 12, wherein the step of the business process is one of a plurality of steps of the business process, one or more of the plurality of steps operable to initiate a data update.

15. The system of claim 12, wherein the one or more processing units are further operable to track which business rules are evaluated for the step in the business process by storing an association of the evaluated business rules with the step in the business process.

16. The system of claim 12, wherein each business rule comprises rule information comprising one or more of the following:
an explanation for the business rule;
a rule expression for the business rule;
an algorithm for the business rule;
an identification of one or more entities that correspond to the business rule;
an identification of one or more attributes that correspond to the business rule; and
a level of enforcement for the business rule.

17. The system of claim 12, wherein the one or more processing units are operable to store the one or more evaluated business rules in a cache such that if the step of the business process is executed at a future time, the one or more business rules may be retrieved from the cache.

18. The system of claim 12, wherein the one or more processing units are operable to determine, if it is determined that performing the data update will violate a particular one of the one or more business rules that correspond to the entity affected by the data update, the appropriate action to initiate for handling the determined violation based on a level of enforcement for the particular business rule.

19. The system of claim 18, wherein the appropriate action comprises one or more of the following:
returning a violation code;
returning an explanation for the violation of the business rule;
returning an indication that the data update should be allowed, but that special authorization is required;
returning an indication that the data update should be allowed, but that a process should be initiated to compensate for the consequences of the violation;
communicating a notification of the violation; and
recording information about the violation for analysis or audit.

20. The system of claim 12, wherein the one or more processing units are operable to, if it is determined that performing the data update would violate the business rule:
report the violation of the business rule; and
allow the data update to be performed.

21. The system of claim 12, wherein the one or more processing units are operable to:
if it is determined that performing the data update would not violate the business rule, allow the data update to be performed; and
if it is determined that performing the data update would violate the business rule, prevent the data update from being performed.

22. The system of claim 12, wherein the data update comprises one or more of:
a request to add data to one or more storage mediums;
a request to modify data stored in one or more storage mediums; and
a request to delete data stored in one or more storage mediums.

23. Software for integrating business rules into automated business processes, the software being embodied in computer-readable media and when executed operable to:
identify an entity affected by a data update initiated by a step of an automated business process;
access a rule registry comprising a plurality of business rules, each business rule corresponding to one or more entities;
determine which business rules in the rule registry to evaluate by determining from the plurality of business rules one or more business rules that correspond to the entity affected by the data update;
for each of the business rules determined to correspond to the entity affected by the data update:
evaluate the business rule in context to determine whether performing the data update would violate the business rule; and
if it is determined that performing the data update would violate the business rule, raise an exception in accordance with the violated business rule.

24. The software of claim 23, wherein:
for each of the one or more entities to which a business rule corresponds, the business rule further corresponds to one or more attributes of the entity; and
the software is further operable to:
determine for the entity affected by the data update one or more attributes affected by the data update;
determine which business rules in the collection of business rules to evaluate by determining from the plurality of business rules one or more business rules that correspond both to the entity affected by the data update and to the one or more attributes affected by the data update.

25. The software of claim 23, wherein the step of the business process is one of a plurality of steps of the business process, one or more of the plurality of steps operable to initiate a data update.

26. The software of claim 23, further operable to track which business rules are evaluated for the step in the business process by storing an association of the evaluated business rules with the step in the business process.

27. The software of claim 23, wherein each business rule comprises rule information comprising one or more of the following:
an explanation for the business rule;
a rule expression for the business rule;
an algorithm for the business rule;
an identification of one or more entities that correspond to the business rule;
an identification of one or more attributes that correspond to the business rule; and
a level of enforcement for the business rule.

28. The software of claim 23, operable to store the one or more evaluated business rules in a cache such that if the step of the business process is executed at a future time, the one or more business rules may be retrieved from the cache.

29. The software of claim 23, operable to determine, if it is determined that performing the data update will violate a particular one of the one or more business rules that correspond to the entity affected by the data update, the appropriate action to initiate for handling the determined violation based on a level of enforcement for the particular business rule.

30. The software of claim 29, wherein the appropriate action comprises one or more of the following:
returning a violation code;
returning an explanation for the violation of the business rule;
returning an indication that the data update should be allowed, but that special authorization is required;
returning an indication that the data update should be allowed, but that a process should be initiated to compensate for the consequences of the violation;
communicating a notification of the violation; and
recording information about the violation for analysis or audit.

31. The software of claim 23, operable to, if it is determined that performing the data update would violate the business rule:
report the violation of the business rule; and
allow the data update to be performed.

32. The software of claim 23, operable to:
if it is determined that performing the data update would not violate the business rule, allow the data update to be performed; and
if it is determined that performing the data update would violate the business rule, prevent the data update from being performed.

33. The software of claim 23, wherein the data update comprises one or more of:
a request to add data to one or more storage mediums;
a request to modify data stored in one or more storage mediums; and
a request to delete data stored in one or more storage mediums.
